(19) United States
(12) Patent Application Publication
(10) Pub. No.: US 2012/0261105 A1
(43) Pub. Date: Oct. 18, 2012

(54) LED HEAT SINK AND MANUFACTURING METHOD THEREOF

(75) Inventors: Sheng-Huang Lin, New Taipei City (TW); Kuo-Sheng Lin, New Taipei City (TW)

(73) Assignee: ASIA VITAL COMPONENTS CO., LTD., New Taipei City (TW)

(21) Appl. No.: 13/084,565

(22) Filed: Apr. 12, 2011

(51) Int. Cl. F28F 7/00; B23P 15/26

(52) U.S. Cl. 165/185; 29/890.054

(57) ABSTRACT

An LED heat sink and a manufacturing method thereof are disclosed. The LED heat sink includes a main body having a heat receiving section and an extended heat transfer section. The heat transfer section is externally provided with a plurality of receiving grooves for correspondingly connecting with a plurality of radiating fins. The LED heat sink manufacturing method includes the steps of molding a main body using a half-molten metal material and cooling the main body, so that the cooled main body is connected with a plurality of radiating fins to form an integral unit. With the LED heat sink manufacturing method, it is able to manufacture an LED heat sink having a relatively complicated radiating fin structure or being formed of two or more types of materials, and to largely reduce the time, labor and material costs of the LED heat sink.

### FIELD OF THE INVENTION

The present invention relates to an LED heat sink, and more particularly to an LED heat sink that can be manufactured at reduced time, labor and material costs. The present invention also relates to a method of manufacturing the LED heat sink.

### BACKGROUND OF THE INVENTION

A light emitting diode (LED) is a solid-state light source capable of converting electric energy into light energy, and is manufactured using epitaxial growth technique and semiconductor process technology. The LED has the advantages of small volume, low driving voltage, fast response time, vibration-resistant, long service life, and environmentally friendly. Due to the constant development and progress in various technological fields, the LED has been constantly improved in its luminous efficiency since it was invented in 1960. The currently available LED is superior to not only the incandescent light bulb that provides a luminous efficacy of about 10˜20 lm/W, but also the fluorescent tube that provides a luminous efficacy of about 60˜80 lm/W. In view of the constantly progressed LED-related technologies, it is estimated the LED will hopefully reach a luminous efficacy of 100 lm/W within a few years. Since the LED has become the focus among many new-generation solid-state light sources, and since consumers demand for electronic elements with further reduced volume and size, an LED lamp in the form of a bulb has gradually replaced the incandescent light bulb and is now massively and widely applied in lighting devices. Currently, LED lamps have been used in traffic signs, street lamps, home lighting, car lights, advertising lamps, and many other fields to become an unstoppable mainstream in the lighting market.

Among others, the appearance and the brightness are the most important factors in designing the currently widely applied LED lighting devices. Since a highly bright LED bulb would also generate a relatively high amount of heat during the operation thereof, it is therefore also very important to provide the LED bulb with a good heat dissipation design.

Some of the currently available LED lighting devices have a heat dissipation element incorporated thereinto and show some special designs. By doing this, the current heat dissipation elements for the LED lighting devices would have more complicated appearance and structure and require relatively complicated manufacturing process, compared to the conventional heat dissipation elements. For instance, as one of the conventional heat dissipation elements, the heat sink is either assembled from a plurality of stacked radiating fins, which are manufactured by stamping or punching a metal sheet material, or integrally formed by extruding an aluminum material. However, both of the stamping or punching process and the extruding process can only be used to manufacture a heat sink with a relatively simple structure. That is, a heat sink with a relatively complicated structure could not be manufactured via stamping, punching or extruding.

Further, with respect to the aluminum-extruded heat sink, it can only be formed by extruding one single type of metal material, i.e. the aluminum material. For the time being, it is not possible to manufacture a heat sink by extruding two or more different metal materials.

On the other hand, while the heat sink assembled from radiating fins can use several different metal materials, it requires a large amount of time and labor to assemble the radiating fins and therefore requires increased manufacturing cost.

In brief, the conventional LED heat sink manufacturing methods have the following disadvantages: (1) not suitable for manufacturing heat sinks with a relatively complicated structure; (2) not suitable for manufacturing heat sinks with two or more types of different materials; and (3) requiring high manufacturing cost.

### SUMMARY OF THE INVENTION

A primary object of the present invention is to provide an LED heat sink with good heat dissipation effect.

Another object of the present invention is to provide a method for manufacturing an LED heat sink using one single type of material or multiple types of materials.

A further object of the present invention is to provide a method for manufacturing an LED heat sink at reduced manufacturing cost.

To achieve the above and other objects, the LED heat sink according to the present invention includes a main body and a plurality of radiating fins. The main body has a heat receiving section and an extended heat transfer section. The heat transfer section is externally provided with a plurality of receiving grooves. The radiating fins respectively have an insertion end for connecting to the receiving grooves on the main body, and a heat dissipation end outwardly extended from the insertion end. All the heat dissipation ends of the radiating fins together define a heat dissipation section.

To achieve the above and other objects, the LED heat sink manufacturing method according to the present invention includes the steps of (1) preparing a mold having a preformed mold cavity, and a plurality of radiating fins; (2) disposing the radiating fins in the cavity preformed in the mold; (3) injecting a half-molten metal material into the mold to form a main body; and (4) cooling the main body, so that the cooled main body is connected with the radiating fins to form an integral unit.

With the LED heat sink and the manufacturing method thereof according to the present invention, it is possible to provide upgraded heat dissipation efficiency and to selectively form an LED heat sink with one single type of material or with multiple types of materials, so as to achieve the objects of saving materials and reducing manufacturing cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an LED heat sink according to a first embodiment of the present invention;

FIG. 2 is an assembled view of FIG. 1;

FIG. 3 is an exploded perspective view of an LED heat sink according to a second embodiment of the present invention;

FIG. 4 is an assembled view of FIG. 3;

FIG. 5 is an assembled perspective view of an LED heat sink according to a third embodiment of the present invention;

FIG. 6 is an assembled perspective view of an LED heat sink according to a fourth embodiment of the present invention;

FIG. 7 is an assembled perspective view of an LED heat sink according to a fifth embodiment of the present invention;

FIGS. 8, 9 and 10 are front views of different radiating fins for the LED heat sink of the present invention;

FIG. 11 is a flowchart showing the steps included in an LED heat sink manufacturing method according to the present invention; and

FIGS. 12, 13 and 14 illustrate the steps of the LED heat sink manufacturing method of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

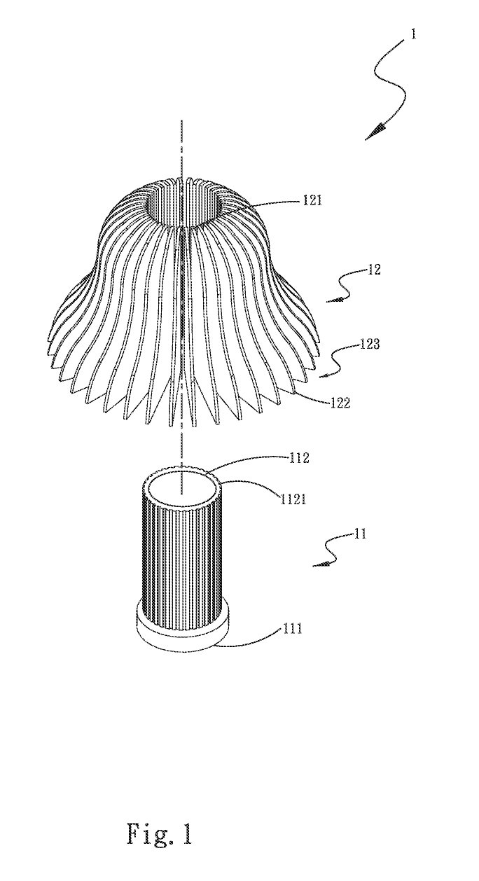

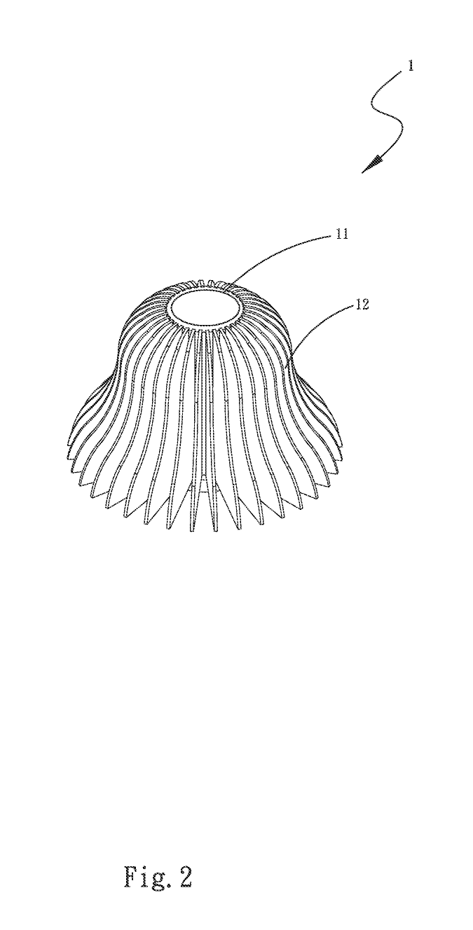

Please refer to FIGS. 1 and 2 that are exploded and assembled perspective views, respectively, of an LED heat sink according to a first embodiment of the present invention. As shown, the LED heat sink is generally denoted by reference numeral 1, and includes a main body 11 and a plurality of radiating fins 12.

The main body 11 of the LED heat sink 1 has a heat receiving section 111 and an extended heat transfer section 112. The heat transfer section 112 is externally provided with a plurality of receiving grooves 1121.

The radiating fins 12 respectively have an insertion end 121 and a heat dissipation end 122. The insertion ends 121 are correspondingly connected to the receiving grooves 1121. The heat dissipation ends 122 are outwardly extended from the insertion ends 121, and all the heat dissipation ends 122 together define a heat dissipation section 123.

In the illustrated first embodiment, the main body 11 is a hollow cylindrical body. The heat receiving section 111 is located at an end of the main body 11, and the heat transfer section 112 is oppositely extended from the heat receiving section 111. The receiving grooves 1121 are circumferentially spaced on and axially extended along an outer surface of the heat transfer section 112 of the main body 11. The radiating fins 12 are externally and radially located around the main body 11.

The main body 11 and the radiating fins 12 can be made of the same material or two different materials. In the embodiments of the present invention, the LED heat sink 1 is described with the main body 11 and the radiating fins 12 being made of different materials without being limited thereto. In the first embodiment, the main body 11 is made of a copper material with good thermal conductivity, and the radiating fins 12 are made of an aluminum material with good heat dissipation efficiency. However, it is also possible to use the same material, such a copper material or an aluminum material, to manufacture the main body 11 and the radiating fins 12.

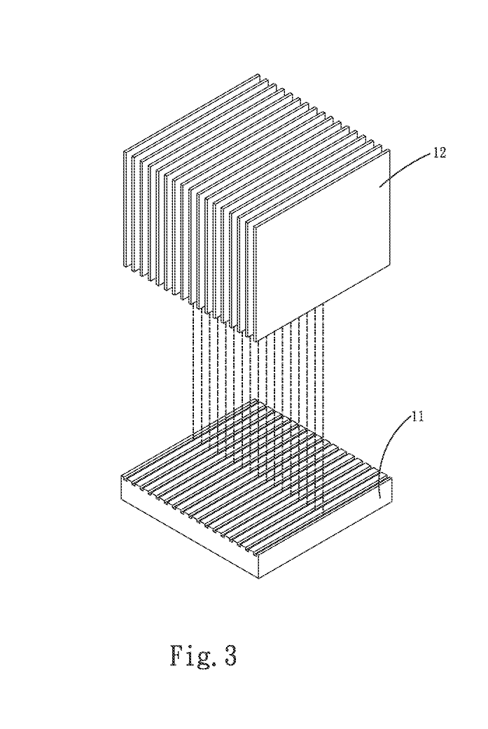

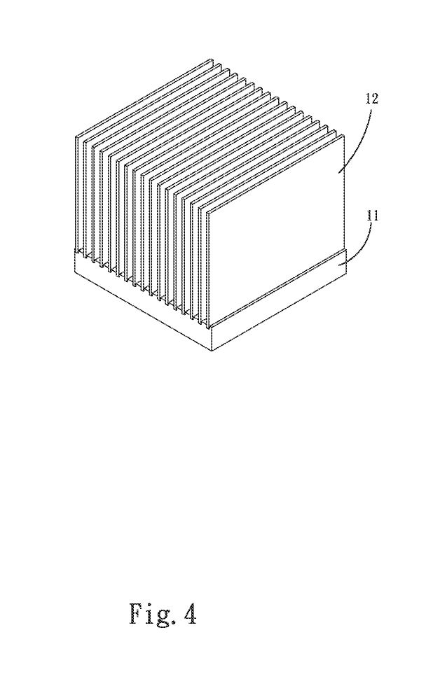

FIGS. 3 and 4 are exploded and assembled perspective views, respectively, of an LED heat sink according to a second embodiment of the present invention. As shown, the LED heat sink in the second embodiment is generally structurally similar to the LED heat sink 1 in the first embodiment, except that, in the second embodiment, the main body 11 is configured as a flat base and the radiating fins 12 are perpendicularly inserted into one of two opposite faces of the main body 11.

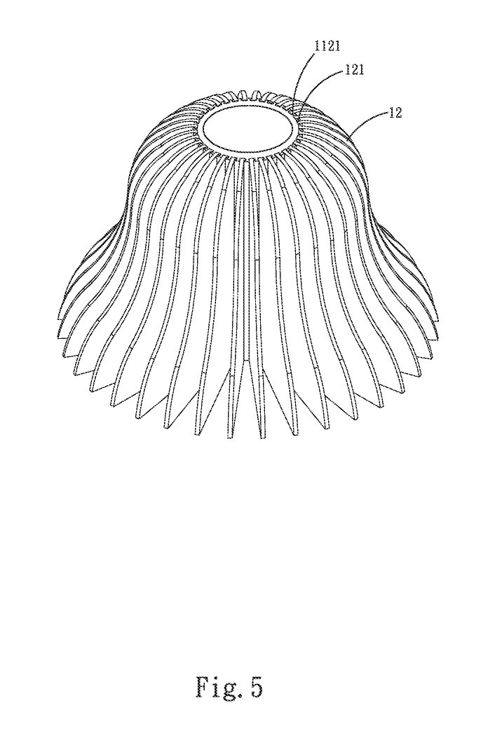

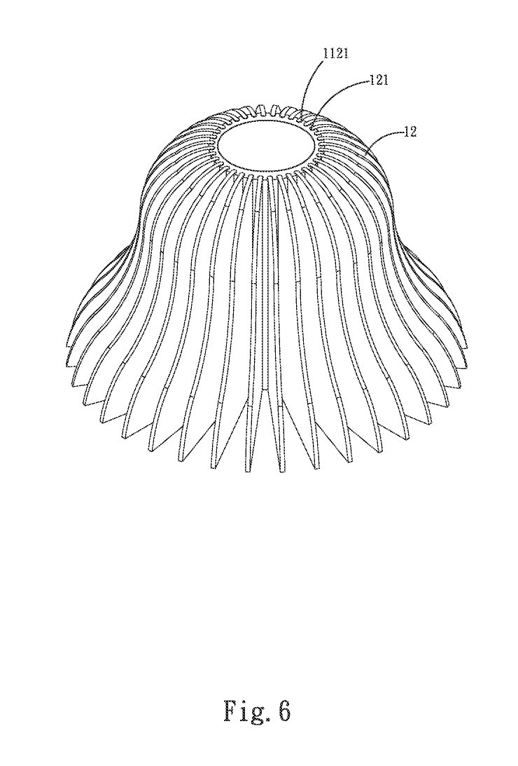

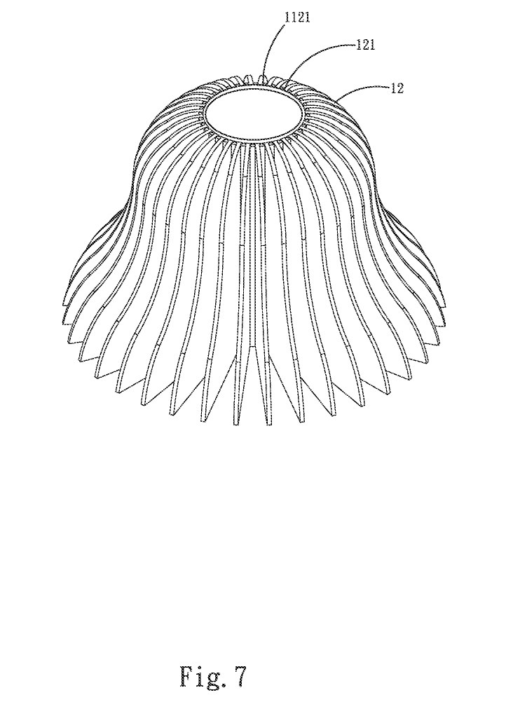

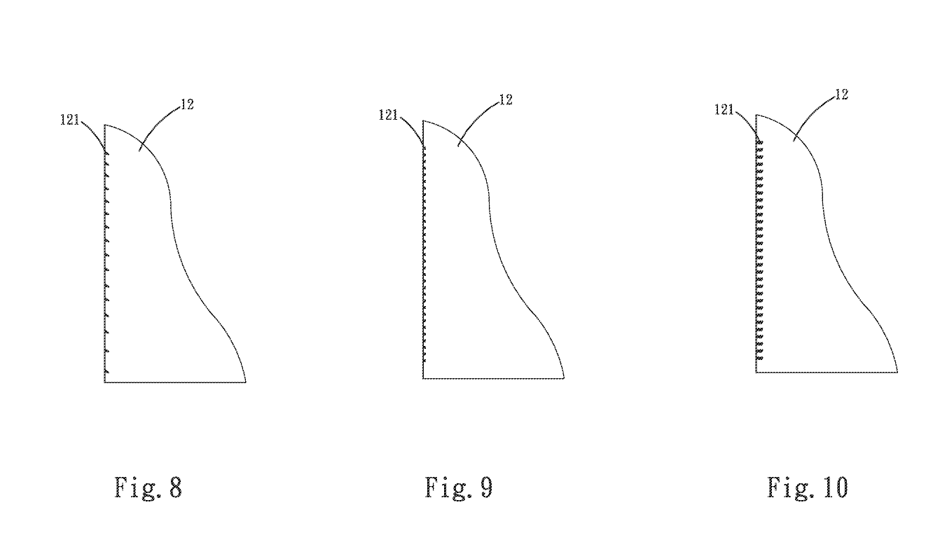

Please refer to FIGS. 5, 6 and 7 that are assembled perspective views of LED heat sinks according to a third, a fourth and a fifth embodiment of the present invention, respectively; and to FIGS. 8, 9 and 10 that are front views of different radiating fins 12 for the LED heat sink of the present invention. In the LED heat sink of the present invention, the insertion ends 121 of the radiating fins 12 may be differently configured to respectively be a longitudinally extended integral concave and protrusion unit or a plurality of longitudinally spaced concave and protrusion units. Each of the concave and protrusion units may have an L-shaped cross section as in the third embodiment of the LED heat sink shown in FIG. 5, or an expanded round cross section as in the fourth embodiment of the LED heat sink shown in FIG. 6, or an expanded trapezoidal cross section as in the fifth embodiment of the LED heat sink shown in FIG. 7. In other embodiments, the insertion ends 121 of the radiating fins 12 may be provided with grooves, dents, or cuts. The cuts can be irregular cuts as shown in FIG. 8, or be smooth cuts as shown in FIG. 9, or be saw-toothed cuts as shown in FIG. 10. By providing the above-mentioned concave and protrusion units, grooves, dents or cuts, it is possible for the insertion ends 121 to firmly and securely connect to the receiving grooves 1121 on the main body 11.

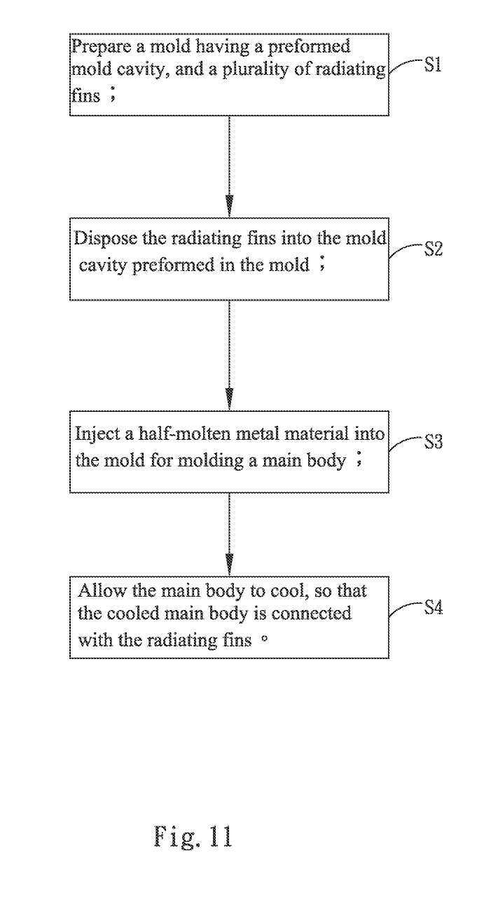

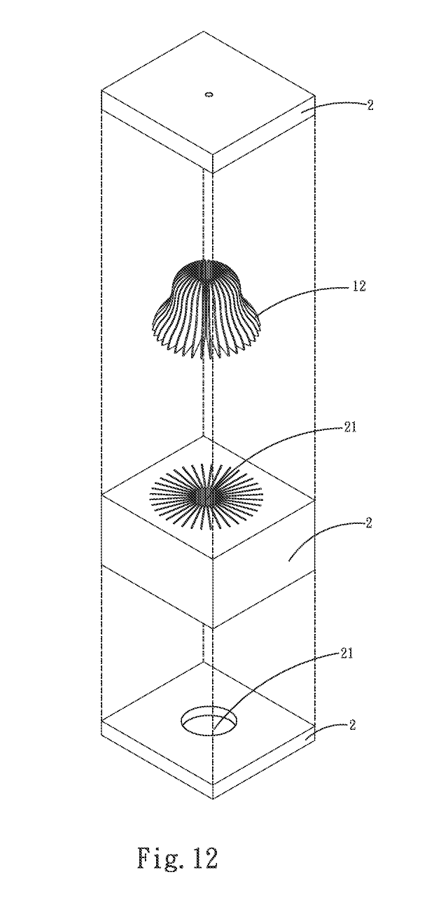

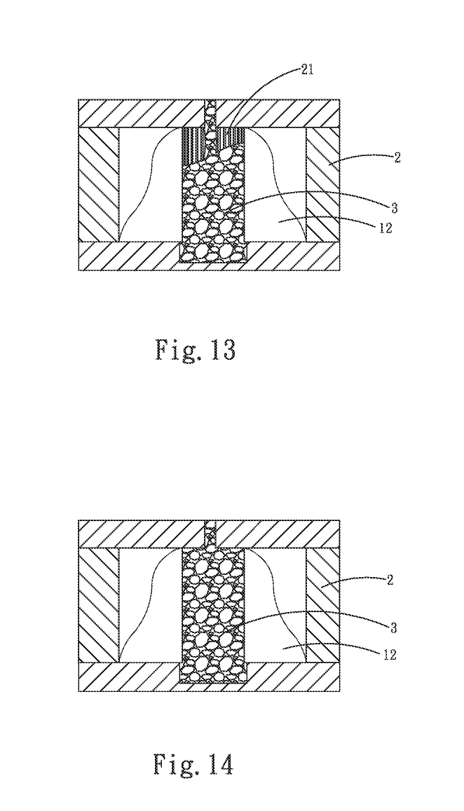

FIG. 11 is a flowchart showing the steps included in an LED heat sink manufacturing method according to the present invention; and FIGS. 12, 13 and 14 illustrate different stages of the LED heat sink manufacturing method. Please refer to FIGS. 11 to 14 along with FIG. 1.

In a first step S1, a mold having a preformed mold cavity and a plurality of radiating fins are prepared.

More specifically, a mold 2 having a preformed mold cavity 21 and a plurality of radiating fins 12 are prepared. The cavity 21 has a shape the same as that of a main body 11 to be formed.

In a second step S2, the radiating fins are disposed in the cavity preformed in the mold.

More specifically, the radiating fins 12 are disposed in the mold 2 and then, the mold 2 is closed.

In a third step S3, a half-molten metal material 3 is injected into the mold for integrally molding a main body.

More specifically, a half-molten metal material is guided into the mold cavity 21 of the mold 2 by way of casting or metal injection molding. It is noted the LED heat sink manufacturing method of the present invention is described and illustrated with metal injection molding without being limited thereto. The half-molten metal material 3 fills the whole mold cavity 21 to form the main body 11.

In a fourth step S4, the formed main body is cooled to thereby connect with the radiating fins.

More specifically, when the half-molten metal material 3 in the mold cavity 21 is cooled and set, the main body 11 is formed and integrally connected with the radiating fins 12.

With the above-described LED heat sink manufacturing method, it is possible to integrally form an LED heat sink with one single type of material or with multiple types of materials to achieve the objects of saving materials and reducing manufacturing cost.

Further, the LED heat sink manufacturing method according to the present invention can be conveniently used to manufacture an LED heat sink 1 having radiating fins with a relatively complicated structure.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An LED heat sink, comprising:
a main body having a heat receiving section and an extended heat transfer section; and the heat transfer section being externally provided with a plurality of receiving grooves; and
a plurality of radiating fins respectively having an insertion end and a heat dissipation end; the insertion ends being correspondingly connected to the receiving grooves on the main body, the heat dissipation ends being outwardly extended from the insertion ends, and all the heat dissipation ends together defining a heat dissipation section.

2. The LED heat sink as claimed in claim 1, wherein the main body and the radiating fins can be made of the same type of material or different types of materials.

3. The LED heat sink as claimed in claim 1, wherein the insertion ends of the radiating fins respectively have a configuration selected from the group consisting of a longitudinally extended integral concave and protrusion unit, a plurality of longitudinally spaced concave and protrusion units, a plurality of grooves, a plurality of dents, and a plurality of cuts.

4. The LED heat sink as claimed in claim 3, wherein the concave and protrusion units respectively have a cross sectional shape selected from the group consisting of an L-shape, an expanded round shape, and an expanded trapezoidal shape.

5. The LED heat sink as claimed in claim 3, wherein the cuts are selected from the group consisting of smooth cuts, irregular cuts, and saw-toothed cuts.

6. The LED heat sink as claimed in claim 2, wherein the main body and the radiating fins are respectively made of a material selected from the group consisting of an aluminum material and a copper material.

7. An LED heat sink manufacturing method, comprising the following steps:
preparing a mold having a preformed mold cavity, and a plurality of radiating fins;
disposing the radiating fins in the cavity preformed in the mold;
injecting a half-molten metal material into the mold for molding a main body; and
allowing the main body to cool, so that the cooled main body is connected with the radiating fins.

8. The LED heat sink manufacturing method as claimed in claim 7, wherein the half-molten metal material is selected from the group consisting of a copper material, an aluminum material, and other metal materials having good thermal conductivity.

9. The LED heat sink manufacturing method as claimed in claim 7, wherein the step of injecting a half-molten metal material into the mold for molding a main body is implemented by way of metal injection molding.

10. The LED heat sink manufacturing method as claimed in claim 7, wherein the step of injecting a half-molten metal material into the mold for molding a main body is implemented by way of casting.
